(19) United States
(12) Patent Application Publication
(10) Pub. No.: US 2026/0145569 A1
(43) Pub. Date: May 28, 2026

(54) TECHNIQUES FOR ENERGY MANAGEMENT OF ELECTRIC VEHICLES

(71) Applicant: Apple Inc., Cupertino, CA (US)

(72) Inventors: Brian J. Tucker, San Jose, CA (US); Blade E. Chapman, Cary, NC (US); Dakshil H. Shah, San Jose, CA (US); Jeffery T. Lee, San Jose, CA (US); Ricardo Javier Arjona Angarita, Campbell, CA (US); Toshiro Yamada, San Francisco, CA (US)

(73) Assignee: Apple Inc., Cupertino, CA (US)

(21) Appl. No.: 19/231,330

(22) Filed: Jun. 6, 2025

Related U.S. Application Data
(60) Provisional application No. 63/725,377, filed on Nov. 26, 2024.

(51) Int. Cl. B60L 53/64; B60L 53/50

(52) U.S. Cl. CPC B60L 53/64; B60L 53/50; B60L 2240/80; B60L 2260/58

(57) ABSTRACT

The techniques described herein relate to energy management. The techniques include receiving a request for an energy guidance signal associated with an electrical energy source for shifting energy consumption used to charge an electric vehicle during one or more time periods. The techniques include receiving one or more characteristics associated with the electrical energy source during the one or more time periods. The techniques include generating the energy guidance signal for the one or more time periods based at least in part on the one or more characteristics of the electrical energy source. The techniques include providing the energy guidance signal to an electric vehicle charging management application for shifting the energy consumption used to charge the electric vehicle during the one or more time periods.

### CROSS-REFERENCES TO RELATED APPLICATIONS

This application claims priority under 35 U.S.C. § 119(e) to U.S. Provisional Application No. 63/725,377, filed on Nov. 26, 2024, entitled “TECHNIQUES FOR INTERACTING WITH THIRD-PARTY ENERGY MONITORING DEVICES,” the contents of each of which are herein incorporated by reference.

### BACKGROUND OF THE INVENTION

Many systems and devices use electrical energy. For example, a system can charge a battery using electrical energy. Many systems that use electrical energy just draw electrical energy whenever needed without knowing anything regarding the electrical energy source that generated the electrical energy.

### BRIEF SUMMARY OF THE INVENTION

The techniques (for example, a method, device, system, or computer-readable medium used to implement the invention as described herein) can include: receiving, at an energy guidance application of a user device, an indication of a request for an energy guidance signal associated with an electrical energy source for shifting energy consumption used to charge an electric vehicle during one or more time periods; receiving, at the energy guidance application, one or more characteristics associated with the electrical energy source during the one or more time periods; generating, by the energy guidance application, the energy guidance signal for the one or more time periods based at least in part on the one or more characteristics of the electrical energy source; and providing, by the energy guidance application, the energy guidance signal to an electric vehicle charging management application for shifting the energy consumption used to charge the electric vehicle during the one or more time periods.

### BRIEF DESCRIPTION OF THE DRAWINGS

FIG. 1 illustrates a block diagram for managing electrical energy usage, according to at least one example of the techniques described herein.

FIG. 2 illustrates a block diagram of devices and/or services used for the techniques described herein regarding managing electrical energy usage, according to at least one example of the techniques described herein.

FIG. 3 illustrates a sequence diagram regarding managing electrical energy usage, according to at least one example of the techniques described herein.

FIG. 4 illustrates a sequence diagram regarding managing electrical energy usage, according to at least one example of the techniques described herein.

FIG. 5 illustrates a graphical depiction of a guidance signal, according to at least one example of the techniques described herein.

FIG. 6 illustrate a flow chart for managing electrical energy usage, according to at least one example of the techniques described herein.

FIG. 7 illustrates an example architecture or environment configured to implement the techniques described herein, according to an embodiment of the present disclosure.

FIGS. 8A-8F. show example application programming interfaces (APIs), according to an embodiment of the present disclosure.

### DETAILED DESCRIPTION OF THE INVENTION

In the following description, various examples will be described. For purposes of explanation, specific configurations and details are set forth in order to provide a thorough understanding of the examples. However, it will also be apparent to one skilled in the art that the examples may be practiced without the specific details. Furthermore, well-known features may be omitted or simplified in order not to obscure the example being described.

Examples of the present disclosure are directed to, among other things, methods, systems, devices, and computer-readable media that provide techniques for managing electrical energy usage. In some examples, the techniques described herein relate to managing electrical energy usage when charging a battery of an electrical vehicle (EV). Management of electrical energy usage can be useful based on the characteristics of the electrical energy source and/or characteristics of the electrical grid providing the electrical energy.

For example, an electrical grid can provide electrical energy for usage at a variety of sites (for example, businesses and homes) by generating electricity from one or more electrical energy sources. Electrical energy sources can include fossil fuels and/or hydrocarbons (methane, propane, butane, natural gas, petroleum, coal, etc.). Electrical energy sources can also include energy from sources that are considered more environmentally-friendly and/or renewable, such as solar, hydro, wind, or geothermal. Additional other electrical energy sources can include nuclear. However, electrical grids do not usually provide consistent electrical energy. Instead, electrical grids may need to generate electrical energy based on demand. Renewable energy sources tend to be available at certain times which may not coincide with electrical energy demand. On the other hand, some electrical energy sources can be used to meet demand during peak demand times. For example, an electrical grid may generate more electrical energy from hydrocarbons and/or fossil fuels during peak demand times. An example peak demand time may be in the late afternoon and early evening (for example, between 4 p.m. and 9 p.m.) as people return home from school and work, and use more personal appliances and devices. Similarly, certain times of year may lead to higher electrical energy demand (such as summer when people may use air conditioning).

Managing electrical energy usage based on the characteristics of the electrical energy source and/or characteristics of the electrical grid be used for systems that are able to shift or reduce their electrical energy usage. Shifting electrical energy usage can be useful to shift electrical energy consumption from a peak demand time period to a lower demand time period. Likewise, shifting electrical energy usage can be useful to shift electrical energy consumption from a time period using significant fossil fuels and/or hydrocarbons for electrical energy generation to a time period using primarily renewable electrical energy sources. An example system that is able to shift its electrical energy usage is a system used for charging devices and/or appliances where the charging time is shorter than the amount of time that the device and/or appliance is capable of being charged. For example, a system for charging an electrical vehicle that charges the electrical vehicle overnight while the user is sleeping or at home may not take the complete overnight time to charge the electrical vehicle. Instead, the system may only need a fraction of the overnight time to charge the electrical vehicle. As such, the electrical energy usage can be shifted within the overnight time to a time associated with lower demand or higher usage of renewable electrical energy sources.

An energy guidance application can be used to manage electrical energy usage based on characteristics of the electrical energy source and/or characteristics of the electrical grid. In order for the energy guidance application to have access to the characteristics of the electrical energy source and/or characteristics of the electrical grid, the energy guidance application may have access to important information that needs to be secured for data privacy and data security reasons. Such information may relate to a user's personal information such as address. The energy guidance application may also have access to utility information such as peak demand times. The energy guidance application may also have access to utility information regarding what types of electrical energy sources are used by the utility and under what conditions is each electrical energy source used. For example, the utility information may indicate that peak demand is associated with higher fossil fuel usage during certain hours or time periods.

On the other hand, the energy guidance application may not have access to information regarding electrical energy usage or electrical loads associated with particular devices and/or appliances. Instead, a device management application associated with the particular device and/or appliance may have access to such electrical energy usage or electrical load information. For example, a device or appliance manufacturer such as an original equipment manufacturer (OEM) may have a device management application that has access to electrical energy usage or electrical load information associated with the device and/or appliance. For example, an EV or EV charger can be associated with an EV charging management application. In such cases, the energy guidance application may not be able to determine how to manage the electrical energy usage or electrical loads of the particular devices and/or appliances.

Instead, the energy guidance application can generate one or more guidance signals regarding the characteristics of the electrical energy source and/or characteristics of the electrical grid and provide the guidance signal to device management applications. The guidance signals can incorporate a variety of different information such as utility information and provide consolidated information to the device management applications. The guidance signal can also provide data security and data privacy by not divulging user information to the device management application and not sharing the utility information with the user and/or device management application. These guidance signals can be associated with an application programming interface (API) which can be accessed by the device management application.

In one example, a guidance signal can be a series of guidance values associated with time periods. The guidance values can be indicative of the characteristics of the electrical energy source and/or characteristics of the electrical grid. An example characteristic can include whether an indication of available energy on the electrical grid being a renewable or environmentally friendly electrical energy sources. Another example characteristics can include utility rates that may different during particular time periods such as peak demand time periods. A low guidance value can indicate that characteristics of the characteristics of the electrical energy source and/or characteristics of the electrical grid are more favorable, such as higher usage of renewable energy or low utility rates. These guidance values can be associated with time periods such that a guidance signal can be a forecast of guidance values. For example, a guidance signal may indicate a guidance value of 0.3 is associated with the next 10 hours while a guidance value of 0.7 is associated with the three following hours.

The one or more guidance signals can be provided to other applications via the API including the device management application. The device management application can use the guidance signals and the electrical energy usage or electrical load information associated with the device in order to manage the electrical energy consumption of the device. For example, an EV charging management application can use the guidance signal and the information regarding the EV and EV charger to determine when to use electricity to charge the car. For example, the EV may be parked at home and charging overnight after the user returns from work. The EV charging management application may have access to a charging deadline (whether expressly obtained from the user or deduced based on past history) and can determine when to charge the EV based on the guidance signals. For example, the EV charging management application may determine that the EV will need to be charged for four hours overnight and use the guidance signals to determine the best four hours to charge the EV. The EV charging management application can also have access to charging conditions and battery information to determine the optimal charging time under certain conditions (for example, not using fast charging because that may decrease a battery's lifespan).

The data privacy and data security of the device information can also be preserved by the device management application which may not share this information with the energy guidance application. Additionally, the device management application and the energy guidance application can be operating on the same user device. In this way, the data transfer between the applications can happen on the user's device for further data privacy and data security benefits.

The device management application can receive feedback signals from the device and/or appliance. For example, the device management application can receive feedback signals that indicate when the EV charger was actually using energy to charge the EV. Similarly, the feedback signals can include electrical load information and EV battery capacity. The device management application can provide one or more feedback signals and/or information derived from the feedback signals to the electrical guidance application. The electrical guidance application can use the one or more feedback signals and/or information derived from the feedback signals in conjunction with guidance signals associated with the same time period to generate insights and/or guidance feedback information. One or more of the insights and/or some or all guidance feedback information can be provided to the device management application. The feedback signals, information derived from the feedback signals, insights, and/or guidance feedback information can be used to evaluate the guidance signal and/or how the guidance signal was used.

The use of an energy guidance signal is a data security and data privacy cognizant way to enable managing electrical energy usage. In some examples, the techniques described herein relate to managing electrical energy usage when charging an EV in order to increase the use of renewable energy while decreasing use of fossil fuels. In some examples, the techniques described herein relate to managing electrical energy usage when charging an EV in order to minimize electrical energy consumption during high demand times for the electrical grid which can both minimize strain to the electrical grid and reduce energy costs.

Turning now to a particular example, a user returns home from work at 6 p.m. The user has an EV that the user charges at home. The user typically leaves their home to go to work at 6 a.m. A device management application on a user device of the user determines that the whole 12 hour time period between arriving at home and leaving at home is not needed to charge the EV. The device management application has enabled a feature to reduce energy consumption during peak demand times and to reduce energy consumption related to fossil fuels. The device management application for the EV requests a guidance signal from the electrical guidance application. The guidance signal can be generated based on utility information and other information. The guidance signal is then provided to the device management application. The device management application determines when to charge the EV based on the guidance signal and information regarding the EV and the EV charger. The device management application determines that charging the EV from 11 p.m. to midnight and 2 a.m. to 3 a.m. accomplishes the charging of the EV based on the guidance signal and EV information. The EV charger then receives control signals to charge the EV from 11 p.m. to midnight and 2 a.m. to 3 a.m.

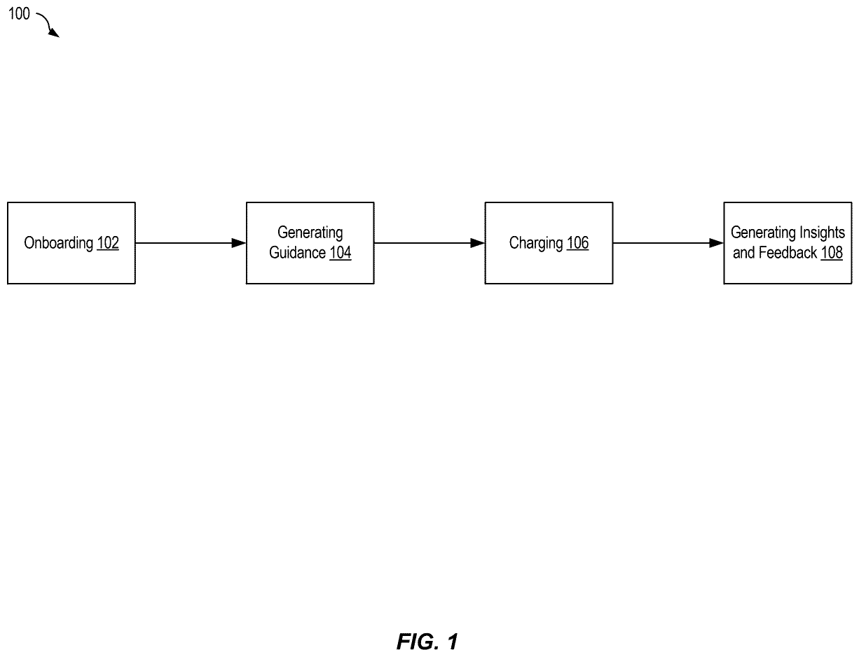

Turning now to the figures, FIG. 1 illustrates a block diagram 100 for managing electrical energy usage, according to at least one example of the techniques described herein. Managing electrical energy usage can include onboarding, generating guidance, charging, and generating insights and feedback.

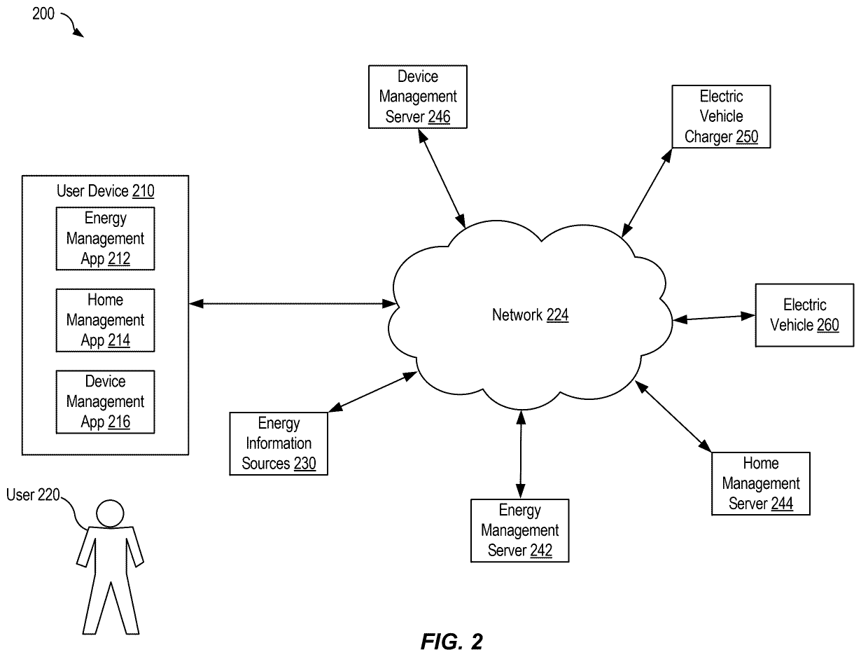

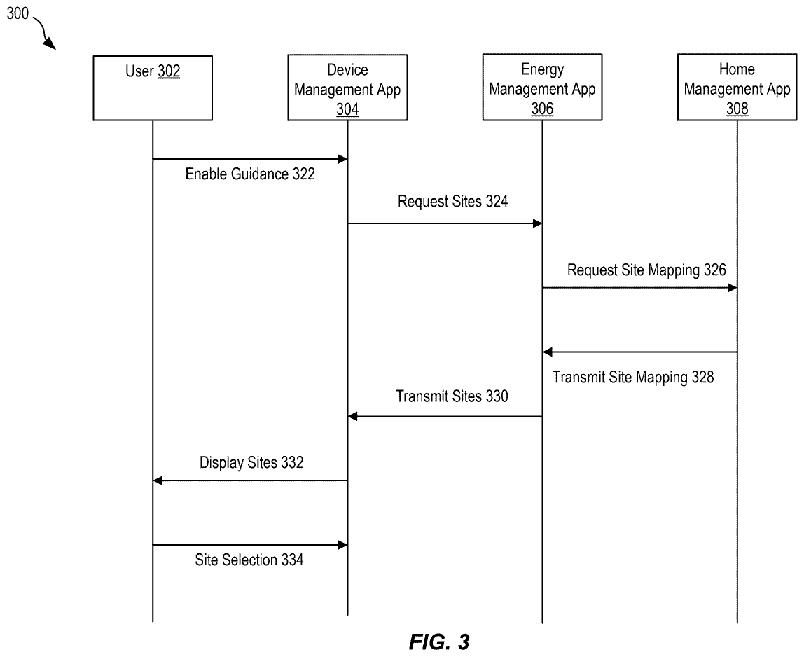

At block 102, onboarding can be completed in order to connect various systems and information sources. Onboarding can include connecting the utility and other information sources with the electrical management application. This connection enables the electrical management application can receive utility and other information in order to determine characteristics of the electrical energy source and the electrical grid. Typically, this is an ongoing connection enabling the electrical management application to receive updated information. Onboarding can also include the user opting into the use of the electrical management application. The user can enable the electrical management application to use utility information for electrical management. For example, the user can enable the electrical management application to use information relating to utility rate plans and utility information for electrical management. Onboarding can also include the user opting into the use of the electrical management application in relation to particular devices and/or appliances. The electrical management application can be connected to the device management application associated with the particular devices and/or appliances. Onboarding is further described in relation to FIGS. 2-3 below.

At block 104, the electrical energy management application can generate guidance signals to provide to the device management application. The guidance signals can be generated based on the utility and other information received from the utility and other information sources. For example, the utility and other information can indicate utility rate plans. The utility and other information can also include information regarding electrical energy sources used by the utility. For example, the utility and other information can indicate that a certain amount of electrical energy is produced by certain electrical energy sources (such as renewable energy sources). Utility and other information can include how the utility may increase electrical energy production if demand increases to certain thresholds. For example, the utility and other information can include information regarding the use of fossil fuels when electrical energy demand reaches certain thresholds. Utility and other information can also include real-time or signals that are nearly real-time regarding electrical energy consumption and demand. In some examples, the utility and other information can include energy storage capabilities of the utility for the storage of electrical energy harvested via renewable energy resources for use at later times.

In some examples, the guidance is generated by the electrical energy management application on the user device after receiving utility information. In some examples, the guidance is generated by one or more servers providing electrical energy management and provided to the user device through the electrical energy management application on the user device. In some examples, a general guidance can be generated by the one or more servers such that the general guidance applies to a zone, region, or community including the user. The general guidance can be provided to the electrical energy management application on the user device which may have access to further utility and other information. The electrical energy management application on the user device can generate personalized guidance based on the general guidance and the further utility and other information. The guidance can also include an indication regarding what was used to generate the guidance. For example, if a utility rate plan was used to generate the guidance, the guidance can include an indication that a utility rate plan was used to generate the guidance. Likewise, when particular utility information regarding the energy sources was used to determine the guidance, the guidance can include an indication that the particular utility information was used to generate the guidance. Examples of such particular utility information can include utility demand forecasts, what sources are used to generate electricity under which conditions, and the like. Generating guidance is further described herein throughout.

At block 106, charging of an EV can occur based on the previously-generated guidance. The guidance can be provided by the electrical energy management application to a device management application associated with an EV and/or an EV charger (also referred to as an EV charging system). The device management application can use the guidance signal and information related to the EV and/or EV charger to determine a charging schedule. In some examples, the device management application may determine to shift the charging of the EV to a time associated with guidance indicating preferable energy usage (for example, use of renewable energy sources to generate electricity). The device management application can send control signals to the EV and/or EV charger based on the charging schedule. Charging is further described herein throughout.

At block 108, the electrical energy management application, the device(s), and/or the device management application can generate feedback and insights based on what actual occurs regarding the electrical energy consumption. For example, the EV charger and/or EV can generate feedback data including electrical load events, battery capacity percentages, electrical energy usage, and related timing. This feedback data can be used by the electrical energy management application to generate insights regarding the actual use of electrical energy from renewable sources or meeting other criteria (such as lowering energy consumption during peak demand time periods). Generating feedback and insights is further described herein throughout.

FIG. 2 illustrates a block diagram 200 of devices and/or services used for the techniques described herein regarding managing electrical energy usage, according to at least one example of the techniques described herein. A user device 210 associated with a user 220 can connect to a network 224. The network 224 can be a local area network (LAN), wide area network (WAN), and any combination of LAN and WAN (for example, the Internet). The user device 210 can include an energy management application 212, a home management application 214, and a device management application 216. The energy management application 212 can be used to receive energy and utility related information and manage energy usage and consumption. The home management application 214 can be used to connect devices within a home and manage the flow of information between those devices as well as control those devices. The device management application 216 can be associated with a particular device or devices and enables functionality for the particular device(s).

The energy management application 212 can be connected to an energy management server 242 through the network 224. The energy management server 242 can provide energy management services to energy management application 212 on user device 210 and other energy management applications on other devices. One or both of the energy management application 212 and the energy management server 242 can receive utility and other information from the energy information sources 230. The energy information sources 230 can be computer systems associated with governmental agencies, utilities, or other entities. The energy information sources 230 can provide information regarding utilities, the electrical grid, and the use of one or more electrical energy sources. Electrical energy sources can include non-renewable resources such as fossil fuels. Electrical energy sources can also include renewable energy sources such as solar, wind, hydroelectric, and geothermal sources. In some examples, the energy information sources 230 can provide historical information. In some examples, the energy information sources 230 can provide estimates or projected information regarding utilities and other information.

The energy management services can be used to generate one or more general guidance signals related to zones, regions, or an area. The guidance signal may be associated with particular zones or regions based on the utility and other information from the energy information sources 230. The one or more general guidance signals can include a forecast for one or more future time periods. In some examples, the one or more future time periods can include multiple time periods over the next twenty-four hours. Each of the one or more future time periods can have different durations as well. For example, a first future time period can be one hour and a second future time period can be the following two hours. These time periods can have variable time length from one minute up to twenty-four hours, or more if the guidance signal relates to time periods beyond the next twenty-four hours. In some examples, the general guidance signal can be generated by the energy management application 212 on the user device 210. In some examples, the user device 210 has access to particular information from the energy information sources 230 that is not accessible to the energy management service 242. The energy management application 212 can generate personalized guidance signals based on the general guidance signals from the energy management server 242 and information available on the user device 210 (for example, information received from the energy information sources 230).

The home management application 214 can be connected to a home management server 244 through the network 224. The home management application 214 and the home management server 244 can provide different services to connect devices in a home such as smart routers, smart phones, smart televisions, computers, laptops, or a device designed for home management such as a home hub. In some examples, the home management application 214 can have access to utility and other information from energy information sources 230.

The device management application 216 can be connected to a device management server 246 through the network 224. The device management application 216 and the device management server 246 can provide services for managing one or more particular devices. Oftentimes, these device management application 216 and the device management server 246 can provide software functionality for the devices. Example devices can include an EV 260 and an EV charger 250 which can also be connected to the device management application 216 and the device management server 246 via the network 224. The device management application 216 can send control signals to the particular devices to cause the particular devices to perform functions. For example, the device management application 216 can send control signals to the EV 260 and/or the EV charger 250 to enable the techniques described herein.

FIG. 3 illustrates a sequence diagram 300 regarding managing electrical energy usage, according to at least one example of the techniques described herein. In particular, the sequence diagram 300 relates to the onboarding 102 of FIG. 1.

At 322, a user 302 with a user device can enable the guidance feature in the device management application 304. In order for the device management application 304 to enable the use of guidance signals, the user 302 has to enable the receiving of guidance signals at the device management application 304.

At 324, the device management application 304 can request sites from the energy management application 306. The sites can be related to the zones, regions, or areas such as described in relation to energy information sources 230 of FIG. 2. For example, a site can be a home within a zone related to a particular energy grid and one or more electrical energy sources.

At 326, the energy management application 306 can request sites and site mapping from the home management application 308. In some examples, the home management application 308 can request sites and site mapping from a home management server and/or service as described in relation to FIG. 2. The home management application 308 can determine if there are one or more sites associated with the user 302. At 328, the home management application 308 can transmit the sites and site mapping to the energy management application 306.

At 330, the energy management application 306 can transmit sites to the device management application 304. If there is only a single site (for example, the user is associated with a single home), the device management application 304 can automatically determine that the user 302 enabled guidance related to the particular site and the one or more devices associated with the device management application. If there are multiple sites, the device management application 304 can cause the multiple sites to be displayed at 332. At 334, the user 302 can select a site to enable guidance related to that particular site and the one or more devices associated with the device management application 304.

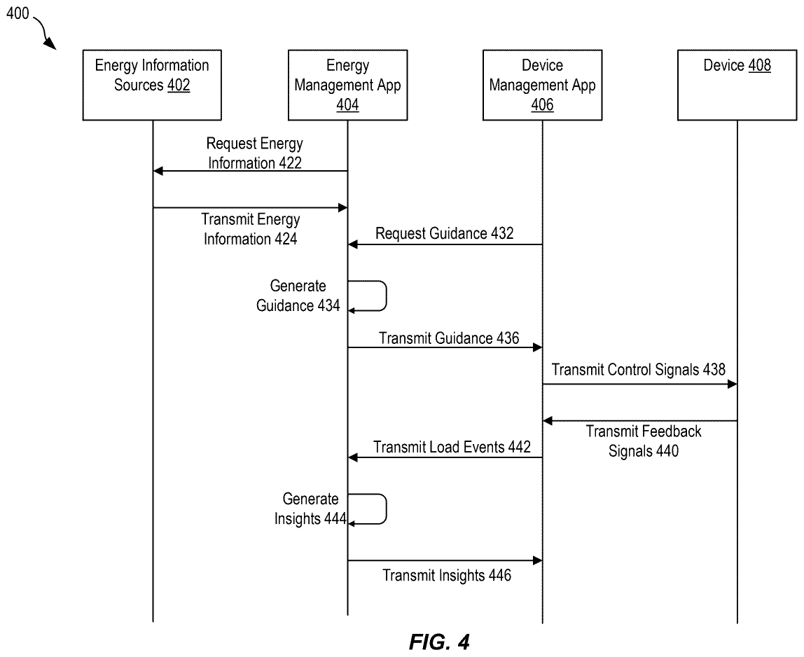

FIG. 4 illustrates a sequence diagram 400 regarding managing electrical energy usage, according to at least one example of the techniques described herein. In particular, the sequence diagram 300 relates to the generating guidance 104, charging 106, and generating insights and feedback 108 of FIG. 1.

At 422, the energy management application 404 can request energy information from the energy information sources 402. Energy information can include utility information such as rate plans, types of energy used at different times (for example, fossil fuels, renewable, natural gas, coal, solar, wind, and the like), and other information regarding the utility or the electrical energy sources used by the utility. At 424, the energy management application 404 receive the energy information from the energy information sources 402. Energy information sources can come from a variety of companies, utilities, governmental entities, or other entities, and their respective systems and/or databases. In some examples, the energy management server 242 of FIG. 2 can request the energy information from the energy information sources 402 and receive the energy information. Then the energy management server 242 can transmit the energy information to the energy management application 404.

At 432, the device management application 406 can request guidance (for example, one or more guidance signals) from the energy management application 404. The guidance can be requested at any time. In some examples, the request for guidance from the device management application 406, the energy management application 404 can request and receive energy information from the energy information sources 402 as described in relation to 422 and 424. In some examples, in response to the request for guidance from the device management application 406, the energy management application 404 can request and receive energy information from the energy management server 242 and the energy management server 242 can, in turn, request and receive energy information from the energy information sources 402 as described in relation to 422 and 424.

At 434, the energy management application 404 can generate guidance (for example, one or more guidance signals). The guidance can be generated based on the energy information (for example, the utility and other information). The guidance can include one or more guidance values and one or more time periods (or durations) associated with those guidance values. The guidance values can be single values that represent multiple characteristics of the electrical energy sources and/or the electrical grid. In some examples, the guidance values can indicate or represent the cleanliness of the energy (for example, renewable electrical energy sources are cleaner than fossil fuel electrical energy sources). For example, the guidance values can reflect a percentage of energy generated from renewable electrical energy sources. In some examples, the guidance values can indicate or represent the utility rate plan information. Utility rate plan information can also be referred to as time of use (TOU) information or time of use utility rates. In some examples, the guidance is generated in response to the request for guidance at 432. In some examples, the guidance is generated periodically such that the guidance may be generated prior to a request for guidance at 432. In some examples, the energy management application 404 can request (in response to the request for guidance at 432) and receive general guidance generated at the energy management server 242 of FIG. 2 in response to the request for guidance at 432. In some examples, general guidance can be generated at the energy management server 242 of FIG. 2 and transmitted to the energy management application 404. In some examples, the general guidance is generated periodically such that the general guidance may be generated prior to a request for guidance at 432. The general guidance can be transmitted from the energy management server 242 to the energy management application 404 prior to the request for guidance at 432. In some examples, the energy management application 404 can generate personalized guidance based on the general guidance received from the energy management server 242. The personalized guidance can include utility and other information that is known on the user device hosting the energy management application 404. In some examples, the utility and other information can include utility rate plans.

At 436, the energy management application 404 can transmit the guidance to the device management application 406. At 438, the device management application 406 can generate and transmit control signals to a device 408 that is managed by the device management application 406. The device 408 can be managed via the control signals to perform certain actions. The control signals can be generated based at least in part on the guidance received. For example, the device management application 406 can manage one or more of an EV and an EV charger (which can both or either be device 408). The control signals can indicate when the EV should be charged by the EV charger. The EV and/or EV charger can cause the EV's battery to be charged based at least in part on the control signals received from the device management application 406.

At 440, the device 408 can transmit feedback signals to the device management application 406. In some examples, the feedback signals can be transmitted while performing the action dictated by the control signals. For example, the feedback signals can be charging and other information from the EV or the EV charger during the charging of the EV's battery. In some examples, the feedback signals can be transmitted at a later time, for example after the action has been performed. For example, the feedback signals can be charging and other information from the EV or the EV charger after the charging of the EV's battery.

At 442, the device management application 406 can transmit load events to the energy management application 404. Load events can be sent periodically or at certain checkpoints. Load events can include a state of charge, a session state, a cumulative energy, and a timestamp relating to the charging of the EV. The state of charge can indicate the percentage of the battery charge. For example, the battery can be at 0% if completely empty or 50% if half full of battery charge. The session state can indicate that the load event is the beginning of the charge cycle or the end of the charge cycle. The session state can also indicate if there is an active electric load being applied to charge the battery or if there is no active electric load because the battery is not charging. The cumulative energy can indicate how much energy has been used during the session (between the start and end state of the charge). The timestamp can indicate when the load event data is being collected and/or sent to the device management application 406 or the energy management application 404.

At 444, the energy management application 404 can generate insights based at least in part on the load events received from the device management application 406. Insights can include energy consumed, cleanliness information, and cost information. Energy consumed can indicate how much total energy was used to charge the EV battery. Cleanliness information can indicate the amount of energy that was used during clean times. Clean times can be determined by the energy management application 404 based on historical data or the guidance that was provided to the device management application 406. Clean times can also be associated with a guidance value threshold such that guidance values below the threshold are considered to be clean. The cleanliness information can also indicate energy that could have been used during a cleaner time period. The cost information can indicate how much energy was used during peak demand, high demand, low demand, or off peak time periods. The timestamps from the load events can be used to determine the cleanliness information and the cost information parts of the insights. At 446, the energy management application 404 can transmit part or all insights to the device management application 406. The energy management application 404 can use the insights as feedback to improve future charging of the EV. The insights can also be transmitted to the energy management server.

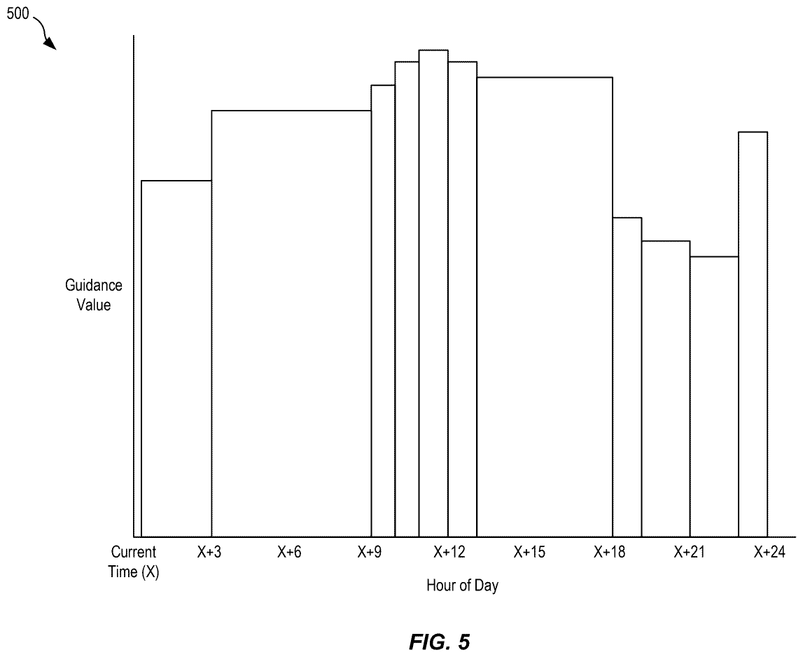

FIG. 5 illustrates a graphical depiction 500 of a guidance signal, according to at least one example of the techniques described herein. The guidance signal includes a set of guidance values and time periods (which can also be represented as durations). In some examples, the guidance values can be between 0 and 1. For example, a guidance value can be 0.1134 or 0.7, or the like. The time periods associated with the guidance values can be any length of time. In some examples, the time periods can have a time length of one minute or a few seconds. In some examples, the time periods can have a time length of hours. Each time period for each guidance value can be different. In some examples, the time period information is a set of durations. For example, a guidance signal may include a first guidance value of 0.7 with a first duration of 3600 seconds and a second guidance value of 0.5 with a second duration of 7200 seconds. In this example, the first guidance value of 0.7 would relate to a first hour and the second guidance value of 0.5 would relate to the two following hours. In some examples, the guidance signal can indicate (for example, with a field) whether the guidance values include utility rate plan information. In some examples, the guidance signal can indicate whether the guidance values include electrical energy source cleanliness information. Electrical energy source cleanliness information can include information regarding whether the electrical energy was generated from a renewable electrical energy source or a fossil fuel electrical energy source.

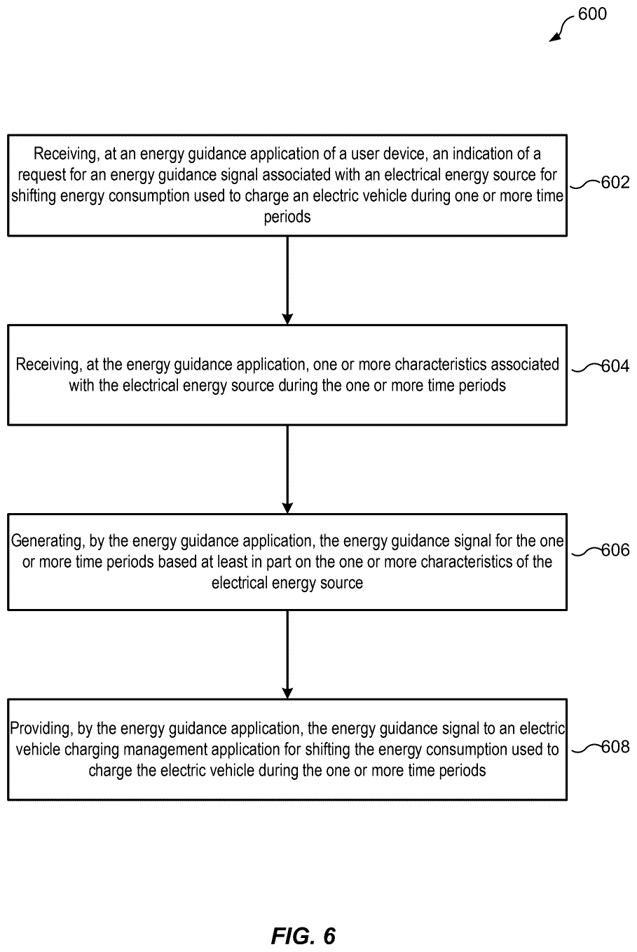

FIG. 6 illustrates a flow chart of an example process 600 for managing electrical energy usage, according to at least one example of the techniques described herein. Example process 600 can be implemented on a user device (for example, user device 210 of FIG. 2) or a server (for example, server 242 of FIG. 2). In some examples, part of process 600 can be implemented on the user device and part of the process 600 can be implemented on the server. If implemented on the server, the energy guidance service of the server associated with the energy guidance application of the user device can perform the parts of the process 600. The energy guidance application can also be referred to as the energy management application (for example, the energy management application 212 of FIG. 2). The energy guidance service can also be referred to as the energy management service.

At block 602, an energy guidance application of a user device can receive an indication of a request for an energy guidance signal associated with an electrical energy source for shifting energy consumption used to charge an electric vehicle during one or more time periods.

At block 604, the energy guidance application can receive one or more characteristics associated with the electrical energy source during the one or more time periods. The one or more characteristics can include cleanliness of energy. The one or more characteristics can include utility rate information.

At block 606, the energy guidance application can generate the energy guidance signal for the one or more time periods based at least in part on the one or more characteristics of the electrical energy source. The guidance signal can include an indication that cleanliness of energy was used to generate the guidance signal. The guidance signal can include an indication that utility rate information was used to generate the guidance signal. The energy guidance signal can include guidance values and associated durations. The guidance values can be indicative of the one or more characteristics.

At block 608, the energy guidance application can provide the energy guidance signal to an electric vehicle charging management application for shifting the energy consumption used to charge the electric vehicle during the one or more time periods. The electric vehicle charging management application can be configured to shift charging of an electric vehicle to a first set of time periods based at least in part the guidance signal. The electric vehicle charging management application can include one or more of: charger information, electric vehicle information, and electric vehicle battery information. The electric vehicle charging management application can be configured to estimate a charging time for the electric vehicle based at least in part on one or more of: the charger information, the electric vehicle information, and the electric vehicle battery information. The electric charging management application can include a charging deadline. The electric charging management application can be configured to determine the charging deadline without user input.

Process 600 can further include receiving, by the energy guidance information, feedback data from the electric vehicle charging management application. The feedback data can include electrical load information. Process 600 can further include generating, by the energy guidance information, insights based at least in part on the feedback data. Process 600 can further include providing, by the energy guidance application, the insights to the electric vehicle charging management application.

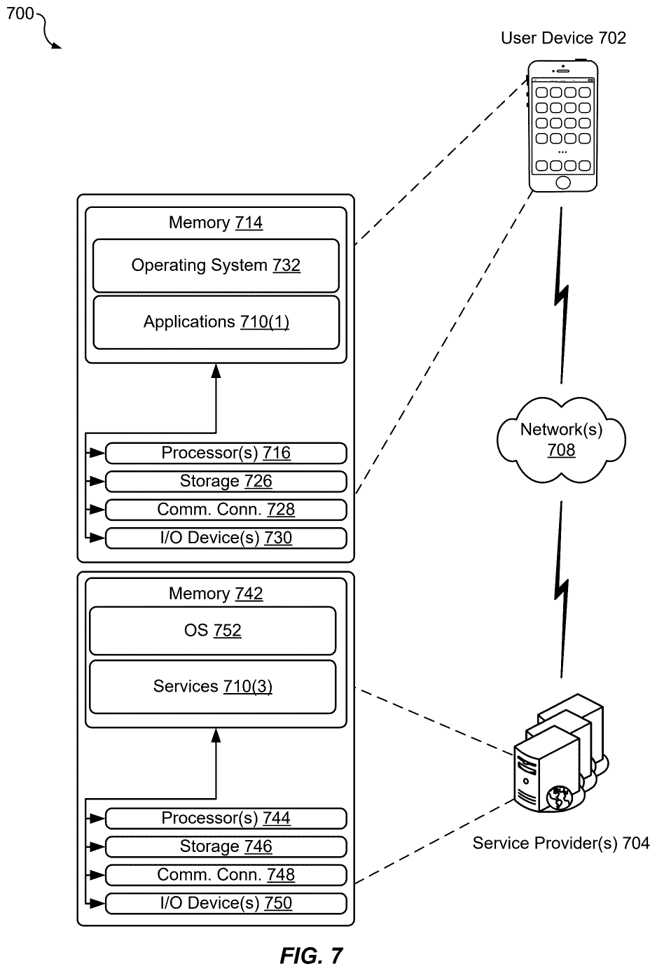

FIG. 7 illustrates an example architecture or environment 700 configured to implement techniques relating managing electrical energy usage, according to at least one example. In some examples, the example architecture 700 may further be configured to enable a user device 702 (e.g., the user device 210 of FIG. 2), the service provider computers 704 (e.g., the energy management server 242, the home management server 244, and the device management server 248) to share information. In some examples, the devices may be connected via one or more networks 708 and/or 706 (e.g., via Bluetooth, WiFi, the Internet, or the like). Additionally, in some examples, the service provider computers 704 and the user device 702 may be configured or otherwise built as a single device. For example, the user device 702 may be configured to implement the examples described herein as a single computing unit, exercising the examples described above and below without the need for the other devices described.

In some examples, the networks 706, 708 may include any one or a combination of many different types of networks, such as cable networks, the Internet, wireless networks, cellular networks, satellite networks, other private and/or public networks, or any combination thereof. While the illustrated example represents the user device 702 accessing the service provider computers 704 via the networks 708, the described techniques may equally apply in instances where the user device 702 interacts with the service provider computers 704 over a landline phone, via a kiosk, or in any other manner. It is also noted that the described techniques may apply in other client/server arrangements (e.g., set-top boxes, etc.), as well as in non-client/server arrangements (e.g., locally stored applications, peer to peer configurations, etc.).

In one illustrative configuration, the user device 702 may include at least one memory 714 and one or more processing units (or processor(s)) 716. The processor(s) 716 may be implemented as appropriate in hardware, computer-executable instructions, firmware, or combinations thereof. Computer-executable instruction or firmware implementations of the processor(s) 716 may include computer-executable or machine-executable instructions written in any suitable programming language to perform the various functions described. The user device 702 may also include geo-location devices (e.g., a global positioning system (GPS) device or the like) for providing and/or recording geographic location information associated with the user device 702.

The memory 714 may store program instructions that are loadable and executable on the processor(s) 716, as well as data generated during the execution of these programs. Depending on the configuration and type of the user device 702, the memory 714 may be volatile (such as random access memory (RAM)) and/or non-volatile (such as read-only memory (ROM), flash memory, etc.). The user device 702 may also include additional removable storage and/or non-removable storage 726 including, but not limited to, magnetic storage, optical disks, and/or tape storage. The disk drives and their associated non-transitory computer-readable media may provide non-volatile storage of computer-readable instructions, data structures, program modules, and other data for the computing devices. In some implementations, the memory 714 may include multiple different types of memory, such as static random access memory (SRAM), dynamic random access memory (DRAM), or ROM. While the volatile memory described herein may be referred to as RAM, any volatile memory that would not maintain data stored therein once unplugged from a host and/or power would be appropriate.

The memory 714 and the additional storage 726, both removable and non-removable, are all examples of non-transitory computer-readable storage media. For example, non-transitory computer readable storage media may include volatile or non-volatile, removable or non-removable media implemented in any method or technology for storage of information such as computer-readable instructions, data structures, program modules, or other data. The memory 714 and the additional storage 726 are both examples of non-transitory computer storage media. Additional types of computer storage media that may be present in the user device 702 may include, but are not limited to, phase-change RAM (PRAM), SRAM, DRAM, RAM, ROM, Electrically Erasable Programmable Read-Only Memory (EEPROM), flash memory or other memory technology, compact disc read-only memory (CD-ROM), digital video disc (DVD) or other optical storage, magnetic cassettes, magnetic tape, magnetic disk storage or other magnetic storage devices, or any other medium that can be used to store the desired information and that can be accessed by the user device 702. Combinations of any of the above should also be included within the scope of non-transitory computer-readable storage media. Alternatively, computer-readable communication media may include computer-readable instructions, program modules, or other data transmitted within a data signal, such as a carrier wave, or other transmission. However, as used herein, computer-readable storage media does not include computer-readable communication media.

The user device 702 may also contain communications connection(s) 728 that allow the user device 702 to communicate with a data store, another computing device or server, user terminals, and/or other devices via the networks 708, 706. The user device 702 may also include I/O device(s) 730, such as a keyboard, a mouse, a pen, a voice input device, a touch input device, a display, an operating system 732 and/or one or more application programs or services for implementing the features disclosed herein including one or more applications 710(1) (for example, the energy management application 212, the home management application 214, and the device management application 216 of FIG. 2). In some examples, the applications 710(1) may be configured to implement the features described herein. The service provider computer 704 may also include a memory 742 that includes services 710(3) (for example, the services associated with the energy management server 242, the home management server 244, and the device management server 246). In this manner, the techniques described herein may be implemented by any one, or a combination of more than one, of the computing devices (e.g., the user device 702 or the service provider computer 704).

The service provider computers 704 may also be any type of computing device such as, but not limited to, a mobile phone, a smartphone, a PDA, a laptop computer, a desktop computer, a thin-client device, a tablet computer, a wearable device, a server computer, a virtual machine instance, etc. In some examples, the service provider computers 704 may be in communication with the user device 702 via the networks 708, 706, or via other network connections.

In one illustrative configuration, the service provider computers 704 may include at least one memory 742 and one or more processing units (or processor(s)) 744. The processor(s) 744 may be implemented as appropriate in hardware, computer-executable instructions, firmware, or combinations thereof. Computer-executable instruction or firmware implementations of the processor(s) 744 may include computer-executable or machine-executable instructions written in any suitable programming language to perform the various functions described.

The memory 742 may store program instructions that are loadable and executable on the processor(s) 744, as well as data generated during the execution of these programs. Depending on the configuration and type of service provider computer 704, the memory 742 may be volatile (such as RAM) and/or non-volatile (such as ROM, flash memory, etc.). The service provider computer 704 may also include additional removable storage and/or non-removable storage 746 including, but not limited to, magnetic storage, optical disks, and/or tape storage. The disk drives and their associated non-transitory computer-readable media may provide non-volatile storage of computer-readable instructions, data structures, program modules, and other data for the computing devices. In some implementations, the memory 742 may include multiple different types of memory, such as SRAM, DRAM, or ROM. While the volatile memory described herein may be referred to as RAM, any volatile memory that would not maintain data stored therein once unplugged from a host and/or power would be appropriate. The memory 742 and the additional storage 746, both removable and non-removable, are both additional examples of non-transitory computer-readable storage media.

The service provider computer 704 may also contain communications connection(s) 748 that allow the service provider computer 704 to communicate with a data store, another computing device or server, user terminals and/or other devices via the networks 708, 706. The service provider computer 704 may also include I/O device(s) 750, such as a keyboard, a mouse, a pen, a voice input device, a touch input device, a display, speakers, a printer, etc.

Turning to the contents of the memory 742 in more detail, the memory 742 may include an operating system 752 and/or one or more application programs or services for implementing the features disclosed herein including the services 710(3).

Implementations within the scope of the present disclosure can be partially or entirely realized using a tangible computer-readable storage medium (or multiple tangible computer-readable storage media of one or more types) encoding one or more computer-readable instructions. It should be recognized that computer-executable instructions can be organized in any format, including applications, widgets, processes, software, and/or components.

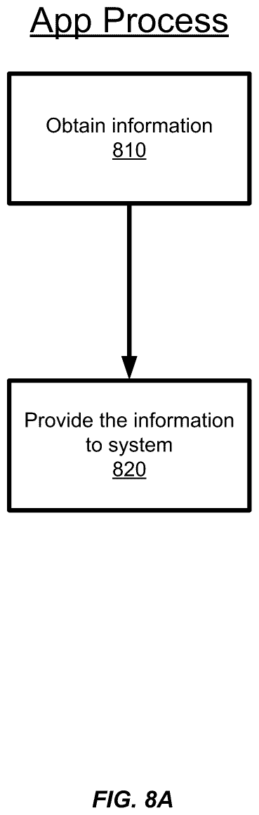

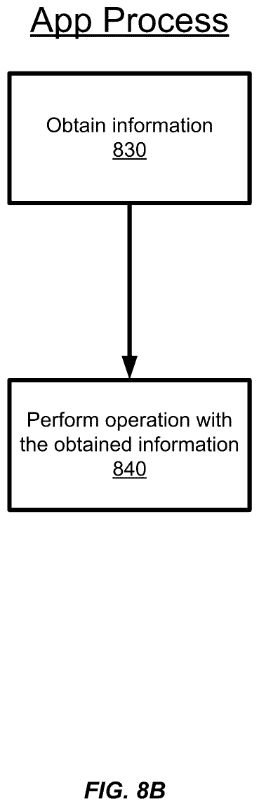

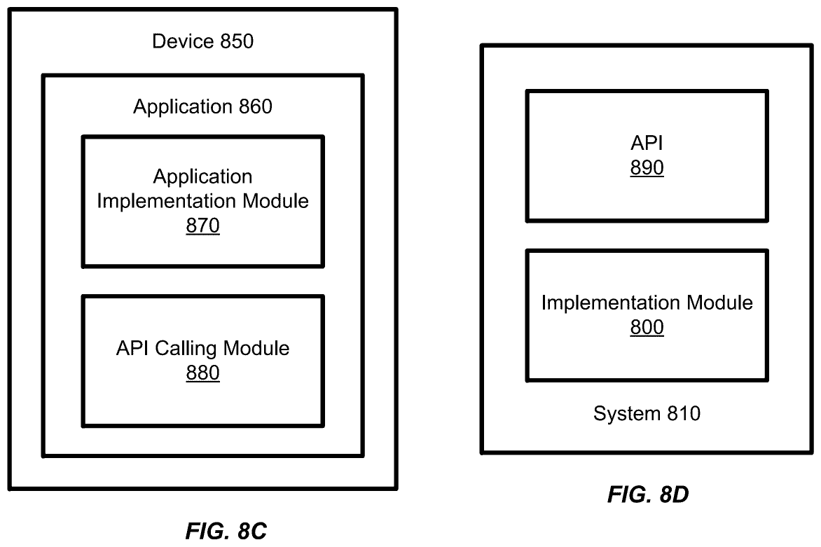

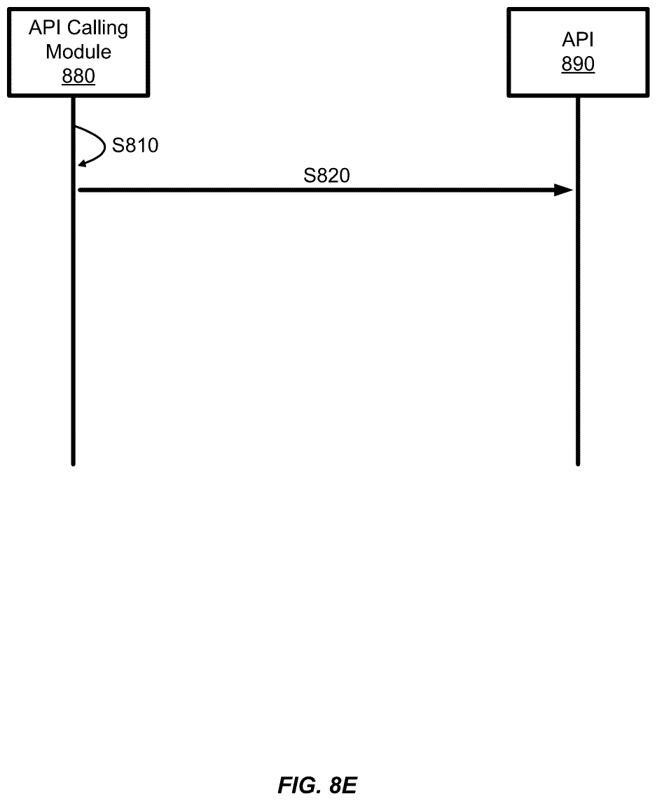

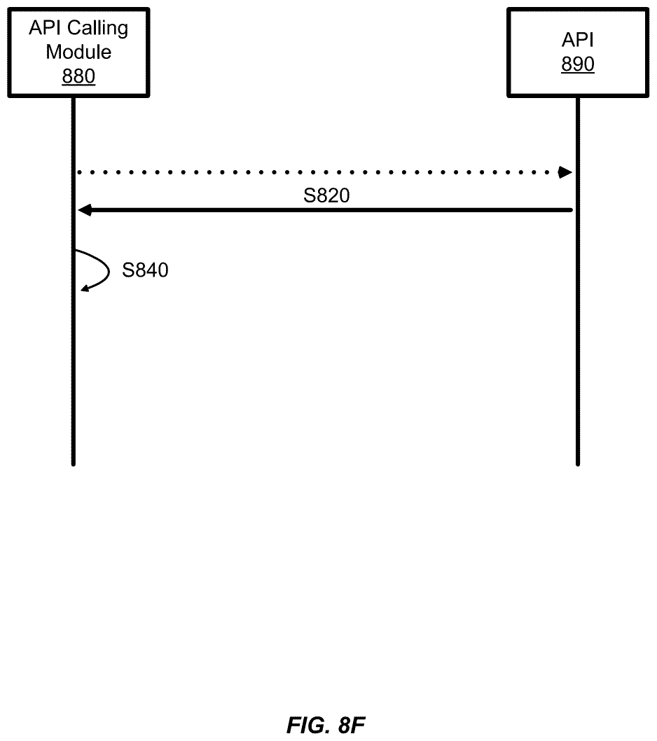

Implementations within the scope of the present disclosure include a computer-readable storage medium that encodes instructions organized as an application (e.g., application 860) that, when executed by one or more processing units, control an electronic device (e.g., device 850) to perform the method of FIG. 8A, the method of FIG. 8B, and/or one or more other processes and/or methods described herein.

It should be recognized that application 860 (shown in FIG. 8C) can be any suitable type of application, including, for example, one or more of: an accessory companion application, a browser application, an application that functions as an execution environment for plug-ins, widgets or other applications, a fitness application, a health application, a digital payments application, a media application, a social network application, a messaging application, and/or a maps application. In some embodiments, application 860 is an application that is pre-installed on device 850 at purchase (e.g., a first party application). In other embodiments, application 860 is an application that is provided to device 850 via an operating system update file (e.g., a first party application or a second party application). In other embodiments, application 860 is an application that is provided via an application store. In some embodiments, the application store can be an application store that is pre-installed on device 850 at purchase (e.g., a first party application store). In other embodiments, the application store is a third-party application store (e.g., an application store that is provided by another application store, downloaded via a network, and/or read from a storage device).

Referring to FIG. 8A and FIG. 8E, application 860 obtains information (e.g., S810). In some embodiments, at S810, information is obtained from at least one hardware component of the device 850. In some embodiments, at S810, information is obtained from at least one software module of the device 850. In some embodiments, at S810, information is obtained from at least one hardware component external to the device 850 (e.g., a peripheral device, an accessory device, a server, etc.). In some embodiments, the information obtained at S810 includes positional information, time information, notification information, user information, environment information, electronic device state information, weather information, media information, historical information, event information, hardware information, and/or motion information. In some embodiments, in response to and/or after obtaining the information at S810, application 860 provides the information to a system (e.g., S820).

In some embodiments, the system (e.g., 810 shown in FIG. 8D) is an operating system hosted on the device 850. In some embodiments, the system (e.g., 810 shown in FIG. 8D) is an external device (e.g., a server, a peripheral device, an accessory, a personal computing device, etc.) that includes an operating system.

Referring to FIG. 8B and FIG. 8F, application 860 obtains information (e.g., S830). In some embodiments, the information obtained at S830 includes positional information, time information, notification information, user information, environment information electronic device state information, weather information, media information, historical information, event information, hardware information and/or motion information. In response to and/or after obtaining the information at S830, application 860 performs an operation with the information (e.g., S840). In some embodiments, the operation performed at S840 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 810 based on the information.

In some embodiments, one or more steps of the method of FIG. 8A and/or the method of FIG. 8B is performed in response to a trigger. In some embodiments, the trigger includes detection of an event, a notification received from system 810, a user input, and/or a response to a call to an API provided by system 810.

In some embodiments, the instructions of application 860, when executed, control device 850 to perform the method of FIG. 8A and/or the method of FIG. 8B by calling an application programming interface (API) (e.g., API 890) provided by system 810. In some embodiments, application 860 performs at least a portion of the method of FIG. 8A and/or the method of FIG. 8B without calling API 890.

In some embodiments, one or more steps of the method of FIG. 8A and/or the method of FIG. 8B includes calling an API (e.g., API 890) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 8C, device 850 is illustrated. In some embodiments, device 850 is a personal computing device, a smart phone, a smart watch, a fitness tracker, a head mounted display (HMD) device, a media device, a communal device, a speaker, a television, and/or a tablet. As illustrated in FIG. 8C, device 850 includes application 860 and operating system (e.g., system 810 shown in FIG. 8D). Application 860 includes application implementation module 870 and API calling module 880. System 810 includes API 890 and implementation module 800. It should be recognized that device 850, application 860, and/or system 810 can include more, fewer, and/or different components than illustrated in FIGS. 8C and 8D.

In some embodiments, application implementation module 870 includes a set of one or more instructions corresponding to one or more operations performed by application 860. For example, when application 860 is a messaging application, application implementation module 870 can include operations to receive and send messages. In some embodiments, application implementation module 870 communicates with API calling module to communicate with system 810 via API 890 (shown in FIG. 8D).

In some embodiments, API 890 is a software module (e.g., a collection of computer-readable instructions) that provides an interface that allows a different module (e.g., API calling module 880) to access and/or use one or more functions, methods, procedures, data structures, classes, and/or other services provided by implementation module 800 of system 810. For example, API-calling module 880 can access a feature of implementation module 800 through one or more API calls or invocations (e.g., embodied by a function or a method call) exposed by API 890 and can pass data and/or control information using one or more parameters via the API calls or invocations. In some embodiments, API 890 allows application 860 to use a service provided by a Software Development Kit (SDK) library. In other embodiments, application 860 incorporates a call to a function or method provided by the SDK library and provided by API 890 or uses data types or objects defined in the SDK library and provided by API 890. In some embodiments, API-calling module 880 makes an API call via API 890 to access and use a feature of implementation module 800 that is specified by API 890. In such embodiments, implementation module 800 can return a value via API 890 to API-calling module 880 in response to the API call. The value can report to application 860 the capabilities or state of a hardware component of device 850, including those related to aspects such as input capabilities and state, output capabilities and state, processing capability, power state, storage capacity and state, and/or communications capability. In some embodiments, API 890 is implemented in part by firmware, microcode, or other low level logic that executes in part on the hardware component.

In some embodiments, API 890 allows a developer of API-calling module 880 (which can be a third-party developer) to leverage a feature provided by implementation module 800. In such embodiments, there can be one or more API-calling modules (e.g., including API-calling module 880) that communicate with implementation module 800. In some embodiments, API 890 allows multiple API-calling modules written in different programming languages to communicate with implementation module 800 (e.g., API 890 can include features for translating calls and returns between implementation module 800 and API-calling module 880) while API 890 is implemented in terms of a specific programming language. In some embodiments, API-calling module 880 calls APIs from different providers such as a set of APIs from an OS provider, another set of APIs from a plug-in provider, and/or another set of APIs from another provider (e.g., the provider of a software library) or creator of the another set of APIs.

Examples of API 890 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a bluetooth API, an NFC API, a UWB API, a fitness API, a smart home API, contact transfer API, photos API, camera API, and/or image processing API. In some embodiments the sensor API is an API for accessing data associated with a sensor of device 850. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor and/or biometric sensor.

In some embodiments, implementation module 800 is a system (e.g., operating system, server system) software module (e.g., a collection of computer-readable instructions) that is constructed to perform an operation in response to receiving an API call via API 890. In some embodiments, implementation module 800 is constructed to provide an API response (via API 890) as a result of processing an API call. By way of example, implementation module 800 and API-calling module 880 can each be any one of an operating system, a library, a device driver, an API, an application program, or other module. It should be understood that implementation module 800 and API-calling module 880 can be the same or different type of module from each other. In some embodiments, implementation module 800 is embodied at least in part in firmware, microcode, or other hardware logic.

In some embodiments, implementation module 800 returns a value through API 890 in response to an API call from API-calling module 880. While API 890 defines the syntax and result of an API call (e.g., how to invoke the API call and what the API call does), API 890 might not reveal how implementation module 800 accomplishes the function specified by the API call. Various API calls are transferred via the one or more application programming interfaces between API-calling module 880 and implementation module 800. Transferring the API calls can include issuing, initiating, invoking, calling, receiving, returning, and/or responding to the function calls or messages. In other words, transferring can describe actions by either of API-calling module 880 or implementation module 800. In some embodiments, a function call or other invocation of API 890 sends and/or receives one or more parameters through a parameter list or other structure.

In some embodiments, implementation module 800 provides more than one API, each providing a different view of or with different aspects of functionality implemented by implementation module 800. For example, one API of implementation module 800 can provide a first set of functions and can be exposed to third party developers, and another API of implementation module 800 can be hidden (e.g., not exposed) and provide a subset of the first set of functions and also provide another set of functions, such as testing or debugging functions which are not in the first set of functions. In some embodiments, implementation module 800 calls one or more other components via an underlying API and thus be both an API calling module and an implementation module. It should be recognized that implementation module 800 can include additional functions, methods, classes, data structures, and/or other features that are not specified through API 890 and are not available to API calling module 880. It should also be recognized that API calling module 880 can be on the same system as implementation module 800 or can be located remotely and access implementation module 800 using API 890 over a network. In some embodiments, implementation module 800, API 890, and/or API-calling module 880 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

In some embodiments, process 600 (FIG. 6) is performed at one or more of a user device and a server (as described herein) via one or more system processes (e.g., an operating system process, a server system process) that is different from one or more applications executing and/or installed on the first computer system.

In some embodiments, process 600 (FIG. 6) are performed at one or more of a user device and a server (as described herein) via one or more system processes by one or more applications that is different from a system process. In some embodiments, the instructions of the one or more applications, when executed, control the one or more of a user device and a server to perform process 600 (FIG. 6) by calling an application programming interface (API) provided by the one or more system processes. In some embodiments, the one or more applications perform at least a portion of process 600 (FIG. 6) without calling the API.

In some embodiments, the application (or the one or more applications) is an application that is pre-installed on the first computer system (for example, the one or more of a user device and a server as described herein) at purchase (e.g., a first party application). In other embodiments, the application is an application that is provided to the first computer system via an operating system update file (e.g., a first party application). In other embodiments, the application is an application that is provided via an application store. In some implementations, the application store is pre-installed on the first computer system at purchase (e.g., a first party application store) and allows download of one or more applications. In some embodiments, the application store is a third party application store (e.g., an application store that is provided by another device, downloaded via a network, and/or read from a storage device). In some embodiments, the application is a third party application (e.g., an app that is provided by an application store, downloaded via a network, and/or read from a storage device). In some embodiments, the application controls the first computer system to perform process 600 (FIG. 6) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a bluetooth API, an NFC API, a UWB API, a fitness API, a smart home API, contact transfer API, photos API, camera API, and/or image processing API.

In some embodiments, at least one API is a software module (e.g., a collection of computer-readable instructions) that provides an interface that allows a different module (e.g., API calling module) to access and use one or more functions, methods, procedures, data structures, classes, and/or other services provided by an implementation module of the system process. The API can define one or more parameters that are passed between the API calling module and the implementation module. In some embodiments, the API 890 defines a first API call that can be provided by API calling module 890. The implementation module is an system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 850) that runs the application. In some embodiments, the implementation module is included in an electronic device that is separate from the device that runs the application.

The various examples can be further implemented in a wide variety of operating environments, which in some cases can include one or more user computers, computing devices, or processing devices which can be used to operate any of a number of applications. User or client devices can include any of a number of general purpose personal computers, such as desktop or laptop computers running a standard operating system, as well as cellular, wireless, and handheld devices running mobile software and capable of supporting a number of networking and messaging protocols. Such a system also can include a number of workstations running any of a variety of commercially-available operating systems and other known applications for purposes such as development and database management. These devices also can include other electronic devices, such as dummy terminals, thin-clients, gaming systems, and other devices capable of communicating via a network.

Most examples utilize at least one network that would be familiar to those skilled in the art for supporting communications using any of a variety of commercially-available protocols, such as TCP/IP, OSI, FTP, UPnP, NFS, CIFS, and AppleTalk. The network can be, for example, a local area network, a wide-area network, a virtual private network, the Internet, an intranet, an extranet, a public switched telephone network, an infrared network, a wireless network, and any combination thereof.

In examples utilizing a network server, the network server can run any of a variety of server or mid-tier applications, including HTTP servers, FTP servers, CGI servers, data servers, Java servers, and business application servers. The server(s) may also be capable of executing programs or scripts in response to requests from user devices, such as by executing one or more applications that may be implemented as one or more scripts or programs written in any programming language, such as Java®, C, C# or C++, or any scripting language, such as Perl, Python, or TCL, as well as combinations thereof. The server(s) may also include database servers, including without limitation those commercially available from Oracle®, Microsoft®, Sybase®, and IBM®.

The environment can include a variety of data stores and other memory and storage media as discussed above. These can reside in a variety of locations, such as on a storage medium local to (and/or resident in) one or more of the computers or remote from any or all of the computers across the network. In a particular set of examples, the information may reside in a storage-area network (SAN) familiar to those skilled in the art. Similarly, any necessary files for performing the functions attributed to the computers, servers, or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, touch screen, keypad), and at least one output device (e.g., a display device, printer, speaker). Such a system may also include one or more storage devices, such as disk drives, optical storage devices, and solid-state storage devices such as RAM or ROM, as well as removable media devices, memory cards, flash cards, etc.

Such devices can also include a computer-readable storage media reader, a communications device (e.g., a modem, a network card (wireless or wired), an infrared communication device), and working memory as described above. The computer-readable storage media reader can be connected with, or configured to receive, a non-transitory computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within at least one working memory device, including an operating system and application programs, such as a client application or browser. It should be appreciated that alternate examples may have numerous variations from that described above. For example, customized hardware might also be used and/or particular elements might be implemented in hardware, software (including portable software, such as applets), or both. Further, connection to other computing devices such as network input/output devices may be employed.

Non-transitory storage media and computer-readable media for containing code, or portions of code, can include any appropriate media known or used in the art, including storage media, such as, but not limited to, volatile and non-volatile, removable and non-removable media implemented in any method or technology for storage of information such as computer-readable instructions, data structures, program modules, or other data, including RAM, ROM, EEPROM, flash memory or other memory technology, CD-ROM, DVD or other optical storage, magnetic cassettes, magnetic tape, magnetic disk storage or other magnetic storage devices, or any other medium which can be used to store the desired information and which can be accessed by a system device. Based at least in part on the disclosure and teachings provided herein, a person of ordinary skill in the art will appreciate other ways and/or methods to implement the various examples.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated examples thereof are shown in the drawings and have been described above in detail. It should be understood, however, that there is no intention to limit the disclosure to the specific form or forms disclosed, but on the contrary, the intention is to cover all modifications, alternative constructions and equivalents falling within the spirit and scope of the disclosure, as defined in the appended claims.

Implementations within the scope of the present disclosure can be partially or entirely realized using a tangible computer-readable storage medium (or multiple tangible computer-readable storage media of one or more types) encoding one or more computer-readable instructions. It should be recognized that computer-executable instructions can be organized in any format, including applications, widgets, processes, software, and/or components.

Implementations within the scope of the present disclosure include a computer-readable storage medium that encodes instructions organized as an application that, when executed by one or more processing units, control an electronic device to perform any of the methods described herein.

It should be recognized that the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, the application is an application that is pre-installed on device at purchase (e.g., a first party application). In other embodiments, the application is an application that is provided to the device via an operating system update file (e.g., a first party application or a second party application). In other embodiments, the application is an application that is provided via an application store. In some embodiments, the application store can be an application store that is pre-installed on the device at purchase (e.g., a first party application store). In other embodiments, the application store is a third-party application store (e.g., an application store that is provided by another application store, downloaded via a network, and/or read from a storage device).

The use of the terms “a” and “an” and “the” and similar referents in the context of describing the disclosed examples (especially in the context of the following claims) are to be construed to cover both the singular and the plural, unless otherwise indicated herein or clearly contradicted by context. The terms “comprising,” “having,” “including,” and “containing” are to be construed as open-ended terms (e.g., meaning “including, but not limited to”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate examples of the disclosure and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain examples require at least one of X, at least one of Y, or at least one of Z to each be present.

Preferred examples of this disclosure are described herein, including the best mode known to the inventors for carrying out the disclosure. Variations of those preferred examples may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

What is claimed is:

1. A computer-implemented method, comprising:
receiving, at an energy guidance application of a user device, an indication of a request for an energy guidance signal associated with an electrical energy source for shifting energy consumption used to charge an electric vehicle during one or more time periods;
receiving, at the energy guidance application, one or more characteristics associated with the electrical energy source during the one or more time periods;
generating, by the energy guidance application, the energy guidance signal for the one or more time periods based at least in part on the one or more characteristics of the electrical energy source; and
providing, by the energy guidance application, the energy guidance signal to an electric vehicle charging management application for shifting the energy consumption used to charge the electric vehicle during the one or more time periods.

2. The computer-implemented method of claim 1, further comprising receiving, by the energy guidance application, feedback data from the electric vehicle charging management application.

3. The computer-implemented method of claim 2, wherein the feedback data includes electrical load information.

4. The computer-implemented method of claim 2, further comprising generating, by the energy guidance application, insights based at least in part on the feedback data.

5. The computer-implemented method of claim 4, further comprising providing, by the energy guidance application, the insights to the electric vehicle charging management application.

6. The computer-implemented method of claim 1, wherein the one or more characteristics includes cleanliness of energy.

7. The computer-implemented method of claim 1, wherein the one or more characteristics includes utility rate information.

8. A device, comprising:
a storage medium configured to store computer-executable instructions; and
one or more processors coupled to the storage medium and configured to execute computer-executable instructions to at least:
receive, at an energy guidance application of the device, an indication of a request for an energy guidance signal associated with an electrical energy source for shifting energy consumption used to charge an electric vehicle during one or more time periods;
receive, at the energy guidance application, one or more characteristics associated with the electrical energy source during the one or more time periods;
generate, by the energy guidance application, the energy guidance signal for the one or more time periods based at least in part on the one or more characteristics of the electrical energy source; and
provide, by the energy guidance application, the energy guidance signal to an electric vehicle charging management application for shifting the energy consumption used to charge the electric vehicle during the one or more time periods.

9. The device of claim 8, wherein the one or more characteristics includes cleanliness of energy.

10. The device of claim 9, wherein the guidance signal includes an indication that cleanliness of energy was used to generate the guidance signal.

11. The device of claim 8, wherein the one or more characteristics includes utility rate information.

12. The device of claim 11, wherein the guidance signal includes an indication that utility rate information was used to generate the guidance signal.

13. The device of claim 8, wherein the electric vehicle charging management application is configured to shift charging of an electric vehicle to a first set of time periods based at least in part the guidance signal.

14. A non-transitory computer-readable storage medium having stored thereon program instructions that, when executed by one or more processors of a computer system, cause the computer system to perform operations, comprising:
receiving an indication of a request for an energy guidance signal associated with an electrical energy source for shifting energy consumption used to charge an electric vehicle during one or more time periods;
receiving one or more characteristics associated with the electrical energy source during the one or more time periods;
generating the energy guidance signal for the one or more time periods based at least in part on the one or more characteristics of the electrical energy source; and
providing the energy guidance signal to an electric vehicle charging management application for shifting the energy consumption used to charge the electric vehicle during the one or more time periods.

15. The non-transitory computer-readable storage medium of claim 14, wherein the electric vehicle charging management application includes one or more of: charger information, electric vehicle information, and electric vehicle battery information.

16. The non-transitory computer-readable storage medium of claim 15, wherein the electric vehicle charging management application is configured to estimate a charging time for the electric vehicle based at least in part on one or more of: the charger information, the electric vehicle information, and the electric vehicle battery information.

17. The non-transitory computer-readable storage medium of claim 14, wherein the energy guidance signal includes guidance values and associated durations.

18. The non-transitory computer-readable storage medium of claim 17, wherein the guidance values are indicative of the one or more characteristics.

19. The non-transitory computer-readable storage medium of claim 14, wherein the electric charging management application includes a charging deadline.

20. The non-transitory computer-readable storage medium of claim 19, wherein the electric charging management application is configured to determine the charging deadline without user input.
